(19) United States
(12) Patent Application Publication
(10) Pub. No.: US 2022/0276721 A1
(43) Pub. Date: Sep. 1, 2022

(54) METHODS AND SYSTEMS FOR PERFORMING OBJECT DETECTION AND OBJECT/USER INTERACTION TO ASSESS USER PERFORMANCE

(71) Applicant: Teqball Holding S.à r.l., Luxembourg (LT)

(72) Inventors: Viktor Huszar, Luxembourg (LU); Laszlo Benke, Luxembourg (LU); Vamsi Kiran Adhikarla, Luxembourg (LU); Gyorgy Gattyan, Luxembourg (LU); Gabor Borsanyi, Luxembourg (LU); Mihaly Gergye, Luxembourg (LU)

(21) Appl. No.: 17/719,258

(22) Filed: Apr. 12, 2022

Related U.S. Application Data
(63) Continuation of application No. 17/388,749, filed on Jul. 29, 2021.
(60) Provisional application No. 63/058,191, filed on Jul. 29, 2020.

(51) Int. Cl. G06F 3/01; A63B 24/00

(52) U.S. Cl. CPC G06F 3/017; A63B 24/0062; A63B 2024/0068; A63B 2220/807; A63B 2243/0025; A63B 2220/05

(57) ABSTRACT

A system and method for object detection may be used to detect the interaction between an object and a part of the human body. In one embodiment, the system is used to detect a soccer ball that is being juggled by a user.

### RELATED APPLICATIONS

This application is a continuation of and claims priority to U.S. application Ser. No. 17/388,749 filed Jul. 29, 2021, which in turn claims the benefit of priority to U.S. Provisional Application No. 63/058,191 filed Jul. 29, 2020, the entirety of which are hereby incorporated by reference.

### FIELD

The present disclosure relates to methods and systems for analyzing user performance, such as a soccer/football performance, utilizing image processing and analysis technologies.

### BACKGROUND

Players or other individuals may wish to improve their skills. These skills may pertain to a particular sport, such as, for example, soccer where, due to the development of ball game sports (e.g.: soccer) that has been achieved in the recent years, the first touch of the players became vital. For instance, an individual may wish to improve their skills in executing certain soccer moves or tricks. However, simply practicing on their own may not give the individual a sense of how accurately or precisely they are executing a particular move, trick or other performance, since there is no actual and valuable feedback.

The existing video and image-based systems applied in ball sports either measure a narrow scope of performance (they monitor the number of passes, the distance performed during a training session or a match), use traditional replay methods supporting the referee (e.g.: video assistant referee (VAR), goal line technology) by applying human decision makers in the background, solely focus on whether the ball has completely crossed the goal line (e.g.: the goal line technology), only works in stadiums well-equipped in terms of hardware (e.g.: the goal line technology), or use predominantly wearable motion sensors as indicators to assess the individual performance. Most of these systems do not monitor, evaluate or quantify the dribbling, ball handling and ball control skills of the users/players (e.g.: the Catapult system) and do not provide information with regard to their respective skills and performance. A few systems present feedback concerning the skills of the users/players, but these systems have experimental character, and they show incomplete and inaccurate information as a result of the uncertain and superficial measurement, without providing actual evaluation or only instruct the user/player how to perform a certain movement (e.g.: HomeCourt).

The above-mentioned known systems are neither designed to receive information with regard to the performance nor to process such information. Consequently, the evaluation of the progress, skills and movement depends entirely on the user. The regulations of ball sports limit wearable items for the sake of safety. As a result, it is desirable to implement a real-time performance analyzing tool, based on object detection by focusing on the position of the ball and image capture. This disclosure describes a system that may address at least some of the issues described above with existing systems and/or other issues and it is to this end that the disclosure is directed.

### BRIEF DESCRIPTION OF THE DRAWINGS

FIG. 1 depicts an example system for analyzing a performance;

FIG. 2 illustrates an example of a client electronic device;

FIG. 3 illustrates a flow chart of an example process of analyzing a performance;

FIG. 4 illustrates a flow chart of an example method of performing circle detection;

FIG. 5. illustrates an example edge image;

FIGS. 6 and 7 illustrate a visual example of modeling movement of a performance piece;

FIG. 8 illustrates the center of an example ball.

FIG. 9 illustrates an example center of a performance piece that is not within an identified threshold area.

FIG. 10 illustrates an example image of a hit candidate;

FIG. 11 illustrates a flow chart of an example method of analyzing a user's performance;

FIG. 12 depicts a block diagram of hardware that may be used to contain or implement program instructions; and

FIGS. 13 and 14 illustrate a first and second examples of the performance rating and the similarity score.

### DETAILED DESCRIPTION OF ONE OR MORE EMBODIMENTS

The disclosure is particularly applicable to system and method for detecting an object in which the object is a soccer ball and the performance is a soccer skill and it is in this context that the disclosure will be described. In one implementation, the system and method may be implemented in an app (downloaded software application having a plurality of lines of instructions, mobile application having a plurality of lines of instructions, etc.) for soccer type skills in which the soccer ball is the object being detected. It will be appreciated, however, that the system and method has greater utility since it can be used to detect various objects and skills performed with those objects with various part of the body. Furthermore, the system and method may be implemented in different ways that disclosed below that are within the scope of the disclosure.

In this disclosure, a performance of the user may be a trick, skill or any action done by the user, such as the soccer skill discussed above. A performance piece may be an object with which the user performs the performance, such as the soccer ball discussed above. One or more pieces of interaction data generated by the system may determine an interaction between a body part of the user and the performance piece during the performance of the user. For example, the interaction data may determine that, in the soccer skill performance using a soccer ball example use case, the head of the user has touched the soccer ball.

The present disclosure generally describes methods and systems for analyzing and rating a performance, such as a soccer/football performance, utilizing artificial intelligence and image processing technologies as discussed below. When a user does a performance using the system, the performance is rated wherein the rating (for example, excellent, good, poor) depends on how skillful the user is during the performance. Such a system may be implemented, in part, through the use of a mobile application, as discussed in more detail below. A user may download and install a software application on his or her computing electronic device (e.g., a smartphone, laptop computer, tablet computer and any other computing system that has at least a processor capable of executing a plurality of lines of computer code/instructions to implement the object detection process, sensors and a display).

In an embodiment that implements the system using an application of a user's computing device, the application may receive sensing data from one or more sensors of a user's computing electronic device to detect or analyze one or more movements of the user as he or she does a performance using a performance piece. The application can be used by a user to compare his or her skills to others, or to help improve his or her own abilities. This disclosure generally discusses one or more soccer tricks as an example of a performance and skills, but it is understood that other performances, as part of other sports or activities, may be detected and analyzed within the scope of this disclosure.

The system and method perform image capture that works irrespective of the frame of reference that enable users (both grassroot and professional players) to significantly improve their skills with a rich set of exercises. The exercises that users can perform using the application, into which the object detection and object/user interaction methods and systems are implemented to assess user performance, may be performed by skilled individuals recognized internationally. In consequence of the aforesaid, the object detection and object/user interaction methods and systems creates a benchmark, based on which the users can compare their skill performance with the best football players of the world. It would clearly indicate objective analysis regarding the set of skills of the users, and the areas where their improvement is necessary.

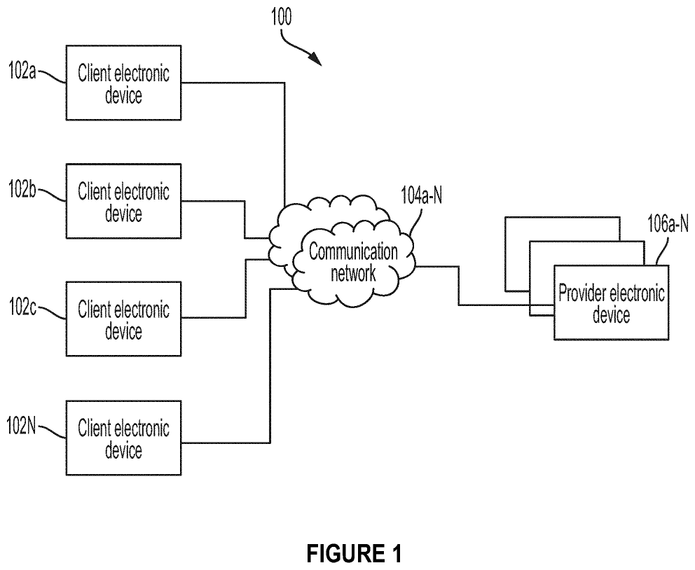

FIG. 1 depicts an example system 100 for analyzing a performance using an object according to various implementations. As illustrated by FIG. 1, the system 100 may include one or more client electronic devices 102a-N, one or more communication networks 104a-N, and one or more provider electronic devices 106a-N. A client electronic device 102a-N may be a mobile electronic device such as, for example, a mobile phone, a tablet, a laptop, a smartwatch, and/or the like. Each electronic device (used by a user) can couple to and connect using the communication networks 104 to one or more of the provider electronic devices 106 and exchange data with that provider electronic devices 106 to perform the object detection and performance analysis discussed below. Alternatively, a client electronic device 102a-N may be a different type of electronic device such as, for example, a desktop computer, laptop computer, tablet computer and/or the like that has at least one processor, memory and one or more sensors that perform the object detection and performance analysis as detailed below. In one embodiment, each electronic device 102 may have a stored (or may download) an application that is a plurality of lines of computer code/instructions executed by the processor of the electronic device so that the electronic device 102 and its processor are configured to perform the processes of the system 100 as discussed below.

The provider electronic device 106a-N may be located remotely from the one or more client electronic devices 102a-N. In various implementations, a provider electronic device 106a-N may be associated with, operated by or controlled by a service provider as described in more detail below. Examples of a provider electronic device 106a-N include, without limitation, laptop computer, a desktop computer, a tablet, a mobile device, a server, a virtual server, a mainframe or other computing or electronic device that each has at least a processor and memory. In some embodiments, at least one of the provider electronic devices 106 may be a backend system comprising one or more server computers that has at least one processor. Each provider electronic device 106a-N may include a plurality of lines of computer code/instructions that may be executed by the processor of the provider electronic device to perform the functions and operations of the provider electronic device as discussed below in more detail.

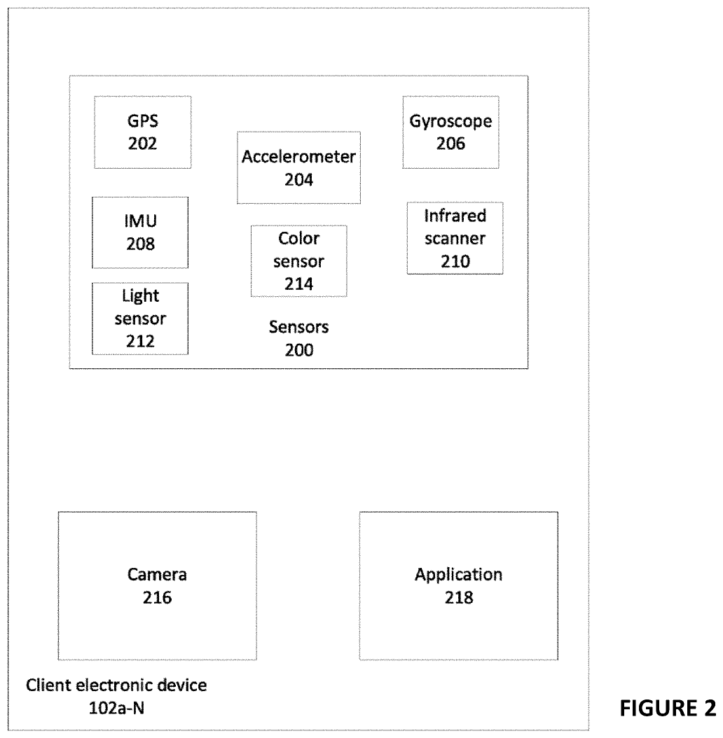

FIG. 2 illustrates an example of a client electronic device 102a-N according to various implementations. As illustrated in FIG. 2, a client electronic device 102a-N may include various sensors 200. These sensors 200 may include, without limitation, a global positioning system (GPS) sensor device 202 that receives positional data from an external GPS network, an accelerometer 204, a gyroscope 206, an inertial measurement unit (IMU) 208, infrared scanner device 210, a light sensor 212, a color sensor 214 and/or the like. A client electronic device 102a-N may include (or be in communication with) one or more cameras 216 such as, for example, a rear-facing camera, a front-facing camera and/or the like. For example, the client electronic device 102 may be smartphone device, such as an Apple® iPhone® or an Android® operating system-based device, that has a housing that has both the rear-facing and front-facing cameras.

In various implementations, each client electronic device 102a-N may have one or more software applications 218 that reside in its memory. A software application 218 refers to one or more programming instructions/instructions or computer code that, when executed by a processor of the client electronic device 102, causes the client electronic device to perform one or more operations according to the programming instructions wherein those operations are discussed below. One of the software applications 218 may include an application associated with a service provider. A user may download and install the application 218 on the user's client electronic device 102. The application may perform or assist in the performance of one or more of the operations described throughout this disclosure. A user may be a subscriber, customer, client or other end user of a service associated with a service provider. It is noted that while the client electronic device 102 itself is known in the art, the combination of the client electronic device 102 and the instructions result in something that is not well known, routine or conventional as discussed below in more detail.

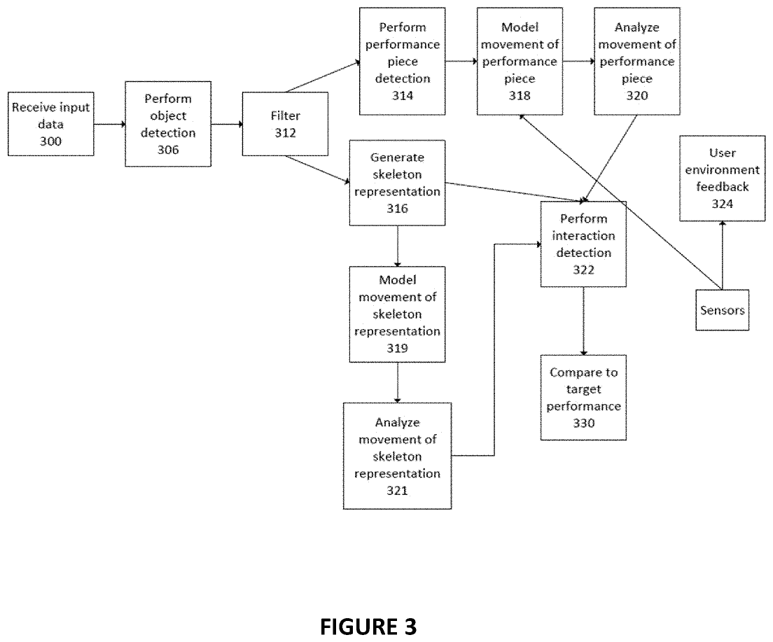

FIG. 3 illustrates a flow chart of an example process of analyzing a performance according to an embodiment. As illustrated in FIG. 3, input data may be received 300 by a client electronic device. The below process may be performed using the electronic devices shown in FIGS. 1-2, but may also be performed by other systems and electronic devices. The input data may be data or information that is measured, observed or otherwise obtained by a client electronic device in connection with a user's performance. For example, a user may position his or her client electronic device so that the user is within view of one or more of the sensors, such as cameras in one embodiment of the user's client electronic device. The user may instruct the client electronic device to begin obtaining inputs by, for example, pressing a button or providing user input via a touchscreen or other input mechanism. For instance, a user may open a software application on the user's mobile electronic device and touch a touchscreen element to indicate that the user is going to be performing a performance that should be observed.

The input data may include image data and/or sensor data. A client electronic device may receive 300 sensor data from one or more sensors of the client electronic device and sensor data refers to information measured or otherwise collected by one or more sensors. A client electronic device may receive 300 image data (when the sensors are cameras in one embodiment) from one or more cameras of a client electronic device. The image data may include one or more frames or images captured by one or more of the cameras of the client electronic device over a period of time. In various implementations, image data may include video data captured by one or more of the cameras of a client electronic device.

In various implementations, a client electronic device 102 may send at least a portion of the sensor data, such as image data when one or more cameras are used, to one or more provider electronic devices 106. The client electronic device 102 may send 302 at least a portion of the sensor/image data in an order that such image data is obtained. For example, in order to properly analyze a performance by a user, it is important that the sensor/image data be considered in the correct order as analyzing sensor/image data out of order may result in a poor rating that is not justified for the user since the rating may be influenced by out of order image data. For example, the user would see vibrating detections in places where no detection should be presented, and this visual problem would also propagate towards the evaluation stage as well. As a consequence of the poor rating, the evaluated data would not present the correct skill performance level of the user on an objective scale: it would show 12% skill level, although in fact the actual level was 50% based on the trajectory of the ball. The system can recognize that the poor rating is not a valid scenario since the system can recognize the data precisely and identify whether the order of the data is correct, or not. In various implementations, continuity of sensor/image data may be maintained by a robust connection protocol such as, for example, the Socket.IO protocol.

A provider electronic device 106 may receive the sensor/image data, and may perform 306 object detection using at least a portion of the received sensor/image data. A provider electronic device may perform object detection on at least a portion of the received data in order to identify one or more objects present in the received data. Each detected object may be a body part of a user, a ball or other performance equipment, and/or the like.

In various implementations, an electronic device 102, 106 may use machine learning and apply one or more machine learning models to at least a portion of the received data and/or information received from one or more sensors in order to detect the one or more objects in the data. A “machine learning model” or a “model” refers to a set of algorithmic routines and parameters that can predict an output(s) of a real-world process (e.g., prediction of an object type, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology and the machine learning methods cannot be performed by a human being or in the human mind.

A typical machine learning pipeline may include building a machine learning model from a sample dataset (referred to as a “training set”), evaluating the model against one or more additional sample datasets (referred to as a “validation set” and/or a “test set”) to decide whether to keep the model and to benchmark how good the model is, and using the model in “production” to make predictions or decisions against live input data. The training set applied by the object detection and object/user interaction methods and systems is based on a set of custom videos showing recorded trials of certain exercises executed by significant number of individuals. Training set is made according to specific instructions, requirements and restrictions defined individually and in line with the described and required operational bound of the application on the user's client electronic device. Training set is created without taking advantage on generalized datasets. Validation set is created according to a process similar to the process applied regarding training set. Validation set consists of a dataset that are presented by another set of custom videos that show recorded trials of certain exercises executed by significant number of individuals selected. Validation set is selected individually, and specifically in order to challenge to training set without following general randomized validation dataset selection from the training set rule. Applying this ‘model’, the object detection and object/user interaction methods and systems can decide and evaluate the live input data in order to present assess the performance of the user/player.

A machine learning model may utilize one or more classifiers in order to model a real-world process. The term “classifier” means an automated process (implemented using a plurality of lines of computer code/instructions executed by a processor of a computer system such as a provider electronic device 106) by which an artificial intelligence system may assign a label or category to one or more data points. A classifier includes an algorithm that is itself trained via an automated process such as machine learning. A classifier typically starts with a set of labeled or unlabeled training data and applies one or more algorithms to detect one or more features and/or patterns within the data that correspond to various labels or classes. For example, a classifier of the object detector may apply one or more algorithms to the received sensor data to detect objects that are present in that data such as, for example, a ball or one or more body parts of a user (e.g., head, arm, hand, leg, torso, foot, etc.).

The classifier may be implemented in various ways that include, without limitation, a decision tree, a Naïve Bayes classification method, and/or algorithms such as k-nearest neighbor, all of which are known in the art. The classifiers further may include artificial neural networks (ANNs), support vector machine classifiers, and/or any of a host of different types of classifiers known or yet to be developed. Once trained, the classifier may then classify new data points using the knowledge base that it learned during training. The process of training a classifier can evolve over time, as classifiers may be periodically trained on updated data, and they may learn from being provided information about data that they may have mis-classified. A classifier may be implemented by a processor executing programming instructions, and it may operate on data sets such as image data and/or other data.

The method in FIG. 3 may perform the object detection 306 by applying one or more machine learning models to at least a portion of the data and the object detection may result in one or more object types detected 306 by the machine learning model(s) and/or one or more coordinates associated with one or more of the object types in the data, such as a frame of image data. The object detection is designed to discover and identify specific body-parts punctually by distinguishing between right side and left side of the body. Such detection is carried out by focusing on the position of the ball regardless of the frame of reference. In addition, the object detection is captured with one non-professional camera incorporated into a mobile device. For example, an object detector performing the object detection process 306 may detect the following object types and coordinates from data as shown in Table 1:

TABLE 1

| Object Type | Coordinates |
|---|---|
| Detected object (ball) | (X, Y, Width, Height) |
| Elbow | (A, B, C, D) |
| Head | (E, F, G, H) |
| Right hand | (I, J, K, L) |

As shown in Table 1, each object type may be detected along with its x and y coordinates in the data, such as its coordinates in a frame of image data. A piece of object data for a particular object may thus include the object type data and the one or more coordinates of the object in the received sensor data. In the example in Table 1, each object that is a part of a user has a unique set of coordinates, but some of those objects could have coordinates that are similar or the same. For example, if a ball object in the data being analyzed is impacted by a head of the user, then the coordinates of the head object and the ball object would be the same or similar that shows an interaction between the head of the user and the ball during a performance by the user.

The provider electronic device 106 may send object data that includes at least a portion of the generated object types and/or corresponding coordinates of those detected objects (collectively the object data for each object) to the client electronic device 102 from which the data was received. The client electronic device 102 may receive that object data for each object. Although this disclosure describes one or more provider electronic devices 106 as performing the object detection analysis, it is understood that a client electronic device 102 (or another electronic device) may perform this analysis, in whole or in part, within the scope of this disclosure.

In various implementations, the client electronic device 102 may filter 312 at least a portion of the input data. Filtering may provide a mechanism to remove noisy or bad data from the data set. For example, the system may know a previous location of a ball (e.g., coordinates associated with a ball object received for the previous time step). If the estimated location of the ball for the current time step is drastically different, the system may filter or remove at least a portion of the input sensor data corresponding to the object that was detected as the ball, as this data is likely incorrect. This filtering is based on a unique system by implementing unique numerical process and data. This filtering may use previous detections, including body detections, that predict the previous position of the ball in order to sort out detections. For instance, if a detected ball is overlapping with a head detection, modification of the detected ball bounding box is recommended, since these detections usually interfere with and affect each other. Additional and/or alternate filtering may be performed according to various embodiments.

The client electronic device 102 may perform 314 performance piece detection on at least a portion of the data from the sensors that may also have been filtered as discussed above. Performance piece detection may be performed to determine a position of an object, such as, for example, a performance piece, during a performance. A performance piece may be a ball, a puck, or another item used in a performance. Circle detection is discussed below with respect to performances that utilize a round ball such as, for example, a soccer ball. However, it is understood that other shapes of performance pieces may be used within the scope of this disclosure. This may include multiple methods, like machine learning based circle detectors and a heavily modified version of the classic Hough Transform detector. These piece detectors are capable to further refine the detections performed. Piece detection called cheat detection is used as well. In this case, the system uses a custom trained machine learning model to determine whether the selected sensor data piece indicates cheating, or not.

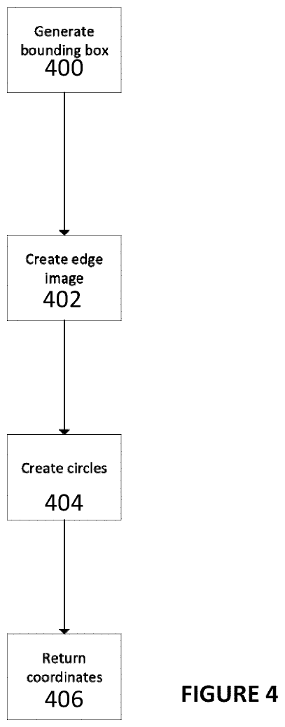

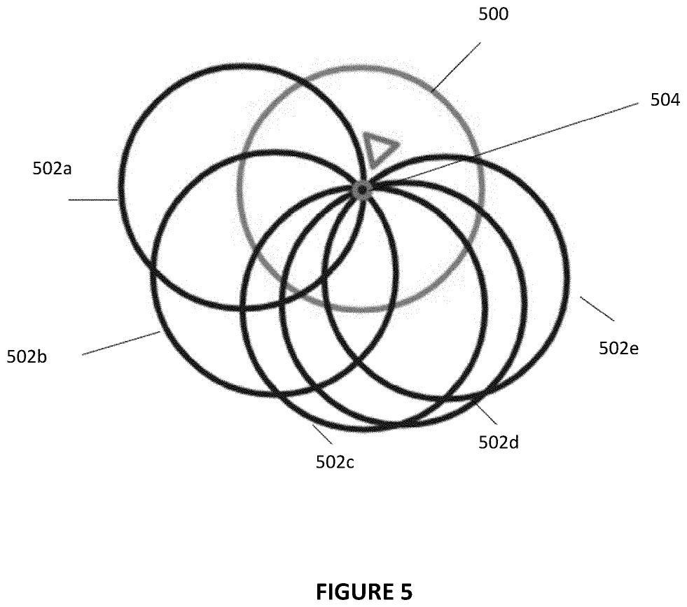

A circle detection algorithm may be utilized to estimate a position of a ball as part of a performance. FIG. 4 illustrates a flow chart of an example method of performing circle detection according to various implementations. As shown in FIG. 4, the system may generate 400 a bounding box that encompasses the object identified by the object detector as the performance piece. For example, the object detector may return one or more coordinates associated with an object from the image data that is identified as being the performance piece. The system may generate and impose 400 a bounding box that encompasses those coordinates. However, this bounding box may encompass more than just the identified performance piece. As such, the process may attempt to locate the performance piece within the bounding box. The system may create 402 an edge image from corresponding image data. The system may create 404 one or more circles on this created edge image having the same diameter as the edge image. This may result in a hotspot located in the middle of the original circle. This circle detection algorithm may repeat this process until it identifies an optimize hotspot for the circle. The method counts all the circles which edge goes through the hotspot and chooses the one with the biggest number. FIG. 5 illustrates an example edge image 500 and a plurality of drawn circles 502a-N, as well as the optimized hotpot 504 for the circle.

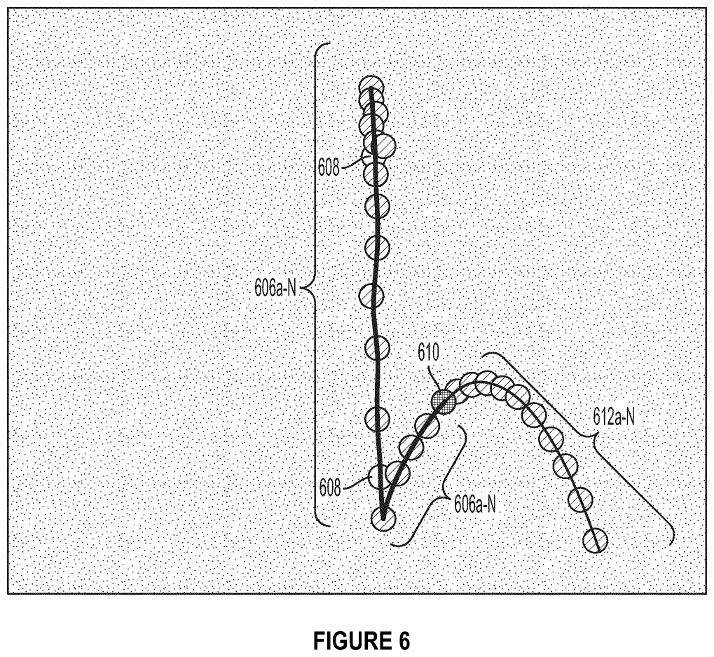

Referring back to FIG. 3, the client electronic device 102 may generate 316 one or more skeleton representations of the user giving the performance using the sensor data and the object data. A skeleton representation refers to a representation of a collection of objects detected from the data, such as image data, arranged in a way to simulate or represent a human body and/or its parts. FIG. 6 illustrates an example skeleton representation of a user according to an implementation. The client electronic device 102 may utilize at least a portion of the output of the object detection process 306 to construct the one or more skeleton representations of a user. For example, the client electronic device 102 may identify one or more objects identified through object detection as belonging to body parts of one or more individuals. These may include objects labeled as head, right arm, right leg, left arm, left leg, torso, right elbow, left elbow, right knee, left knee, left shoulder, right shoulder, and/or the like. The client electronic device may access one or more rules pertaining to human anatomy to generate a skeleton representation of the user. For example, the client electronic device may store in memory or may have access to a database, list or other data structure that defines rules pertaining to how parts of the body are assembled. Example rules may include, without limitation, that a right hand is connected to a right arm, a right elbow is located along a right arm, and a right arm is attached to a right shoulder. Additional and/or alternate rules may be used within the scope of this disclosure.

The client electronic device 102 may confirm, for example, as part of the performance piece detection 314 or the skeleton generation 316, whether the coordinates of the objects that it would like to assemble makes sense in light of the one or more rules. For example, an electronic device may identify a user's head as having coordinates that do not place it above the object identified as the user's shoulders. In this situation, what was identified as the player's head may actually be a ball or another user's head. If an object is identified as being misaligned or otherwise in an unexpected location, the system, depending on other known or unknown parameters, may choose to disable the object, try to find a replacement, create a (temporary) synthetic one, generate an error message, and/or options that seek to either maintain or interrupt the functioning of the overall process.

Once the client electronic device 102 generates 316 a skeleton representation of a user, it may use this skeleton representation to track the position and/or movement of the user throughout the performance from the sensor data and to distinguish the skeleton representation of one user from that of a different user. For example, the skeleton representation for each user will likely be unique since each person may have different length arms or size head, etc. so that a client electronic device may assign a unique number or other identifier to each skeleton representation that the system can use to track the skeleton representations. The system may annotate at least a portion of the data to include information pertaining to one or more generated skeleton representations. For example, one or more of the skeleton representations may be imposed on at least a portion of the data. As another example, information pertaining to one or more skeleton representations may be included in metadata associated with the data.

Referring back to FIG. 3, the client electronic device 102 may model 318 the movement of the performance piece to determine its next likely position. For instance, the client electronic device may analyze and emulate the movement of the performance piece, for example, a ball, to predict where the ball should be next. The client electronic device may analyze and emulate the movement of a skeleton representation to anticipate where one or more relevant body parts, for example, a leg, of the user are expected to be. The movement of the performance piece model considers gravity. In one embodiment, gravity can be calculated regarding the soccer balls since their distance is known based on their size. In one embodiment that uses the application applied on the client electronic device for soccer skills, the system may use soccer balls with regular regulated sizes (5 diameter is around 220 mm) since using different diameters will result anomalies and detection faults.

As part of the performance piece modeling 318, the method may determine, for example, how far away a performance piece is from a sensor, such as a camera, of a client electronic device 102 and how fast the performance piece is moving. The system may account for gravity, and may predict the position of the performance piece for a period of time into the future. For instance, the system may predict a position of a performance piece ten frames into the future. Additional and/or alternate time periods may be used within the scope of this disclosure.

As part of the performance piece modeling 318, the client electronic device may determine the size of the performance piece. The client electronic device may match the determined size with a real world size for the performance piece. For instance, a performance piece may have a standard or regulated size. The client electronic device may access a database, a list or other data structure that may store size information for one or more performance pieces. In the case of a soccer ball, for example, its standard regulated size is 22 cm or 8.66 inches. The client electronic device may estimate how far away the performance piece is from the camera. For example, using trigonometry a client electronic device may determine an angle associated with the field of view of one or more sensors and a size of the performance piece. A distance that the performance piece is away from the one or more sensors, such as cameras, may be determined by dividing a real world size of the performance piece by the tangent of the angle associated with the field of view. In various implementations, the image data may be annotated to include an indication of the determined size of the performance piece. This information may be added to the data, or metadata associated with the data. This information will be applied in the future performance modelling, for instance: giving feedback to the user with regard to the optimal distance from the camera, calculating the distance of the cellphone from the ground, calculating gravity force on the detected ball.

As part of the performance piece modeling 318, the client electronic device may predict a next position of the performance piece. For example, the client electronic device knows (See above) an approximate distance between the performance piece and the sensor, such as a camera. It may apply one or more forces to it to estimate an expected next position for the performance piece. For example, the client electronic device may know what the millimeter equivalent position of a pixel is and it may use this information to calculate what kind of pixel movement the gravitational acceleration would cause of the performance piece. For example, the millimeter equivalent position of a pixel may be based on the size of the performance piece.

The client electronic device may model 319 the movement of the skeleton representation to determine its next likely position. For instance, the client electronic device may analyze and emulate the movement of the skeleton representation or a part of the skeleton representation, for example, the foot, to anticipate where a skeleton representation or a part of a skeleton representation should be next. This may be similar modeling to the object described above except that gravity is not being applied to the parts of the body. One or more of the modeled movements of the performance piece and/or the skeleton representations may be continually analyzed, as described below.

A client electronic device 102, using the model of the movement of the performance piece discussed above, may analyze 320 movements of a performance piece. The client electronic device 102 may determine a current speed of the performance piece and use information from previous frames to make this determination. For example, the speed may be determined using adjacent frames in a sequence, while taking gravitational acceleration into account. By determining a difference between two consecutive points of a performance piece in adjacent frames, the client electronic device 102 may estimate how far the performance piece traveled between the two frames.

The client electronic device, as part of the movement analysis process 320 may determine whether a change occurred in the movement of the performance piece. Based on previous positions and predictions of the performance piece movement, a client electronic device may detect whether a performance piece follows an anticipated trajectory within a threshold deviation value. If the performance piece does not follow an anticipated trajectory within a threshold deviation value, the client electronic device may flag the frame at issue as a direction change (“DC”) candidate.

There is a possibility that the current determination is noisy, so the client electronic device 102 may collect a certain number of consecutive true measurements. If these indicate that the performance piece movement has changed, the client electronic device may flag the first frame of data during which the event occurred. A certain number of frames may have already been processed before a DC was detected, so there may be a buffer of frames to help alter the detection history if need be. If a DC is actually detected, the flagged frame may be sent for interaction analysis as described in more detail below. In various implementations, the image data may be annotated to include information pertaining to one or more DCs. For example, information pertaining to one or more DCs may be added to the image data or to metadata associated with the image data.

In various implementations, if a frame is flagged as a DC candidate, then a next predicted position of the performance piece may not be determined from that frame. Rather, one or more previous predictions may be used instead. If a frame is identified as having an actual DC, then a new trajectory may be started. In this case history data associated with past trajectories that occurred before the frame identified as having an actual DC may not be used. It may be possible to have detection errors. Based on the estimations and previous data, if a detection does not fit with a current ball path, its coordinates may be updated. For example, if there are errors in the detections, the detected noisy coordinates may be replaced with previously estimated, suggested coordinates.

A client electronic device 102 may analyze 321 movements of a skeleton representation or a part of a skeleton representation. The client electronic device may determine a current speed of the skeleton representation or a part of the skeleton representation such as a foot. The client electronic device may use information from previous frames to make this determination. The client electronic device may take into account typical acceleration values for the relevant human body part (as mapped onto a skeleton representation or a part of a skeleton representation) in the given physical context (for example, standing in one approximate area and performing with a ball).

As part of analyzing the movement 321, the client electronic device 102 may determine whether a change occurred in the movement of the skeleton representation or a part of the skeleton representation. Based on previous positions and predictions of the skeleton representation or a part of the skeleton representation, a client electronic device may detect whether a skeleton representation or a part of a skeleton representation follows an anticipated trajectory or deviates from an anticipated trajectory.

If the location of the performance piece differs from an expected location or trajectory, or if the location or movement of the skeleton representation or a part of the skeleton representation differs from an expected location or trajectory, the system may perform an interaction detection or analysis 322 (described in more detail below) to detect whether the change is attributed to a natural bounce or movement change, or because a user interacted with the performance piece, or an error.

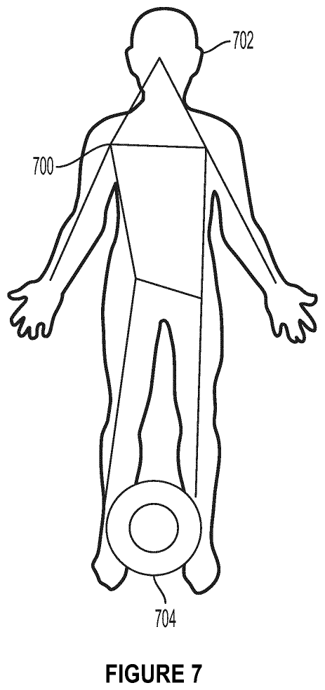

FIGS. 6 and 7 illustrate a visual example of modeling movement of a performance piece according to various implementations. FIG. 7 illustrates a skeleton representation 700 of a user 702 and an estimated performance piece (ball) location 704. FIG. 6 illustrates previously detected locations of the performance piece 606a-N. A previously detected location where a DC candidate was detected is labeled as 608. A previously detected location where a DC is actually detected is labeled as 610. The predictions of future positions of the performance piece are labeled 612a-N.

Referring back to FIG. 3, the client electronic device may perform 322 interaction detection on one or more frames. For instance, if the movement analysis (step 320) suggests that there was an event in the performance piece movement, the system may match that event with one or more of skeleton representations and may detect, assume, and/or predict one or more interactions between the performance piece and at least a part of the user's body. Interaction detection may be used to determine whether a performance piece interacted with something other than a body part such as, for example, the ground, a wall, another object and/or the like. In order for determining the current interaction, an interaction zone is defined regarding the performance piece, which is calculated by the movement differences before and after the event. By applying this method, the system and method can detect on which side of the performance piece the interaction occurred. The interaction zone is checked if there is an intersection with the detected object. In this case, such object is added to the list of possible interaction pieces.

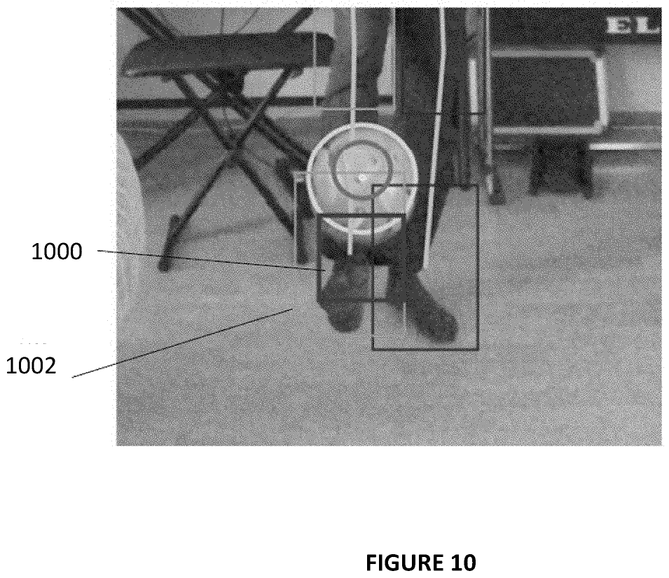

In various implementations, the client electronic device may identify a directional interaction point. The client may determine a directional interaction point based on the vector speed of the performance piece, before and after the direction change. Using the size of the performance piece, the directional interaction area around the directional interaction point may be highlighted. The system may determine whether the directional interaction area overlaps with a bounding box associated with one or more objects in the frame. For instance, the system may determine whether the directional interaction area overlaps with a bounding box associated with one or more body parts. If so, the system may identify each such object (e.g., body part) as a hit candidate. FIG. 10 illustrates an example image of a hit candidate. Square 1000 represents the directional interaction area, while the rectangle 1002 represents a bounding box associated with a user's left foot. As the two areas overlap, the user's left foot is identified as a hit candidate.

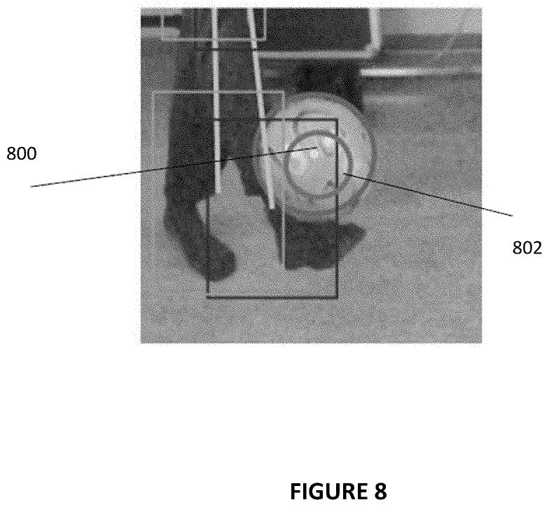

The client electronic device may identify a center of a performance piece and may label this center location on a frame in a certain manner. For example, FIG. 8 illustrates the center of the ball using a dot 800. The client electronic device may identify a threshold area around the center of the performance piece. This threshold area may represent an area within which the center of performance piece may remain to not be considered a direction change. If the center of the performance piece leaves the threshold area, the frame may be flagged as a DC candidate. The threshold area may be labeled on the frame.

For example, in the case of a round ball performance piece, the client electronic device may identify a circular threshold area 802 around the center of the ball. The client electronic device may identify the threshold area by using a previous frame's position prediction. In the previous frame, the predictions indicate where the ball on the next frame should be. Using this prediction, the method knows the estimated area where the ball should be on the current frame.

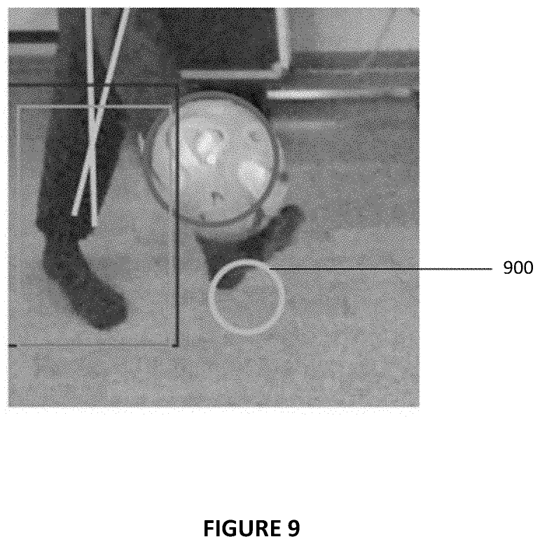

FIG. 9 illustrates an example center of a performance piece (ball) that is not within the identified threshold area. Rather the area labeled 900 shows where the center of the performance piece has been detected. In various embodiments, this new detection area may be labeled differently. For example, a threshold area may be shown in red while a new detection area may be shown in green. The new detection area may follow the previously predicted path until enough frames are collected and processed to flag the frame as a DC with confidence.

In various implementations, interaction detection may be performed 322 to evaluate whether a particular interaction is the start of a performance. For example, a performance may be the performance of a trick by the user on a performance piece, such as a soccer ball. A soccer trick may involve moving a soccer ball in various ways, motions, or patterns using one or more body parts. For instance, a soccer trick may involve bouncing and/or kicking a soccer ball off of one or more body parts in a particular sequence.

If a performance piece movement is a small bounce or a falling movement, it is unlikely to be the start of a performance. In various implementations, a client electronic device may determine that a movement of a performance piece is a performance starter if the performance piece moves or falls faster than a threshold velocity. This threshold velocity is calculated dynamically based in part on the size of the performance piece. In this situation, the client electronic device may flag the frame as a performance starter candidate. In other implementations, if a performance piece begins to move upwards after a DC occurs, then the client electronic device may flag the frame as a performance starter candidate. For example, if a user picks up a performance piece from the ground with his or her feet, the performance piece will likely have a relatively low velocity. However, such a movement may still mark the beginning of a performance given that resting performance pieces do not move upwards without outside interaction.

Referring back to FIG. 3, the client electronic device may provide 324 feedback to the user. The feedback may be based on information obtained by or measured by one or more cameras of the client electronic device and/or one or more sensors of the client electronic device. The feedback that is provided may pertain to the quality of data or information being obtained by the client electronic device.

In various implementations, a client electronic device may store or have access to a database, list and/or other data structure that includes one or more threshold values or ranges of threshold values associated with one or more parameters associated with a preferred performance experience. These parameters may include, for example, a preferred distance of the client electronic device from the ground, preferred lighting conditions, a preferred distance between the user and/or the performance piece and the camera, a preferred steadiness level of the client electronic device, a preferred orientation of the client electronic device and/or the like. For instance, the user may be instructed that the preferred distance from the camera is between 3000 mm and 5000 mm and the distance from the ground should be more than 1000 mm.

The client electronic device may obtain data from one or more cameras and/or one or more sensors and may compare it to one or more of the parameters to determine whether feedback is needed. For instance, if a measurement is not within a threshold range of values for a particular parameter, the client electronic device may determine that feedback is to be provided. As another example, if a measurement or measurements exceed a threshold value or are below a threshold value, the client electronic device may determine that feedback is not necessary. In various implementations, a client electronic device may provide feedback if a measurement or measurements are not within range of a threshold value, or are outside of a range of threshold values for a period of time.

For instance, if the client electronic device is moving too much or too quickly during a performance, it may be difficult for quality images to be captured by the camera. As such, if the IMU of the client electronic device detects that the angular rate of the client electronic device exceeds a threshold value or exceeds a threshold value for a period of time, the client electronic device may provide 324 feedback to the user notifying the user to steady the client electronic device. Feedback may be provided as one or more written alerts, visual alerts, audio alerts and/or the like. For instance, a client electronic device may emit an audio sound and display a window on a user interface of the client electronic device notifying the user to steady the client electronic device.

Similarly, if a gyroscope of a client electronic device detects that a client electronic device is moved from a desirable orientation to an undesirable orientation, the client electronic device may provide 324 feedback to the user notifying the user to adjust the orientation of the client electronic device. Additional and/or alternate types of feedback and/or notifications may be used within the scope of this disclosure.

The electronic device may compare 330 at least a portion of the received information to one or more target performances. In various implementations, an applicable electronic device may generate a similarity score between a user's actual performance and a target performance as part of this comparison. The similarity score may be used to inform the user of the quality of their performance, which may itself indicate the usefulness of their training or their score in a game. If a user's actual performance is similar to a target performance, a provider electronic device may determine a relatively high similarity score for the user's performance. On the other hand, if a user's actual performance differs from a target performance, a provider electronic device may determine a lower similarity score for the user's performance.

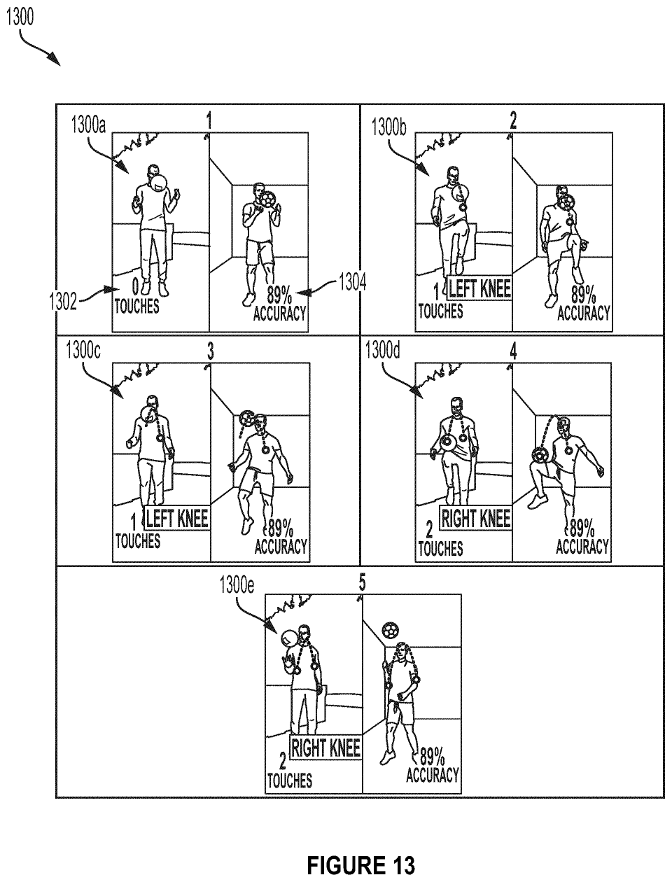

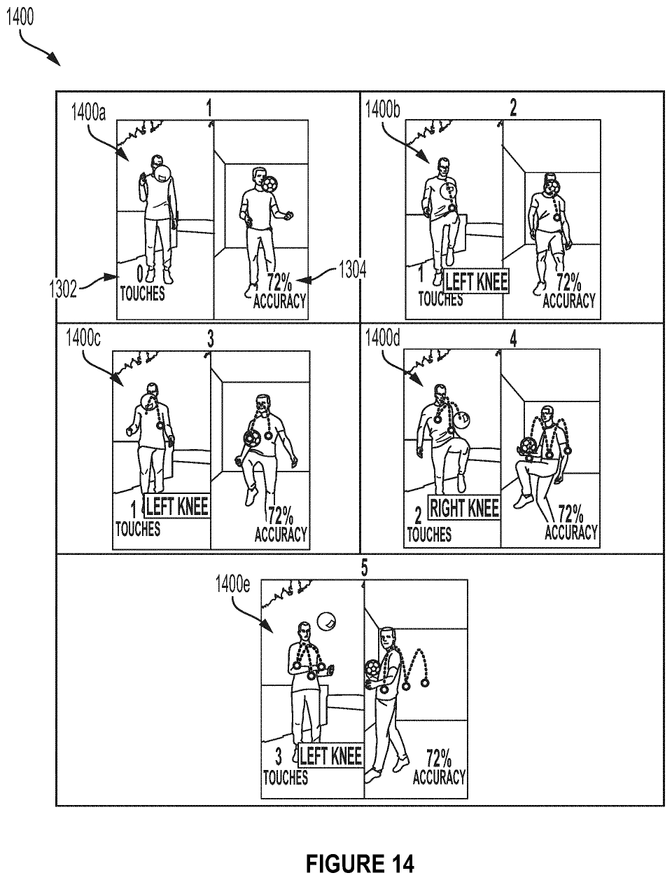

FIGS. 13 and 14 illustrate a first and second example of the performance rating and the similarity score for a user using the application on the user's client electronic device in one embodiment of the system. In these examples, the performance object is a soccer ball and the performance are one or more soccer juggling skills although the system and method is not limited to soccer skills. While the application provides a video of the performance of the user, FIGS. 13 and 14 show one or more still images 1300a-1300e and 1400-1400e of that video to illustrate the video shown the performance rating and similarity score. The video, as shown in each image 1300a-1300e and 1400a-1400e, has a left portion 1302, 1402 and a right portion 1304, 1404 that are side by side. The left portion 1302, 1402 shows a target performance and the skills being performed (including text describing the skills (such as left knee for a left knee juggle) and a count of the skills in the performance). The right portion 1304, 1404 may be a performance of a user in which the user is trying to emulate the target performance. As shown in the figures, the right portion may show the user attempting the target performance and an accuracy score that compares the user performance to the target performance.

In the examples in FIGS. 13 and 14, the user is being asked to do a performance in which a soccer ball is being juggled on each of the knees of the user and that performance is being compared to the target performance (shown in the left portions 1302, 1402) that is being performed, in this example, by a former football player who is one of the greatest Brazilian players of all time. For the first user whose performance is shown in FIG. 13, the generated performance rating and similarity score define that the accuracy of the actual performance is 89%, which is above average. For the second user (or same user trying the performance again) as shown in FIG. 14, the generated similarity score of the actual performance is different when the performance is of lower quality: 72% as can be seen in the right portions 1404 in FIG. 14 showing the user trying to mimic the target performance.

A target performance refers to a performance that a user is supposed to be performing, having certain characteristics. An application may allow a user to perform in a single player mode or battle mode. In single player mode, a user may select or be provided with a particular performance that the user is to replicate. A user may be provided with a target performance via the application on the user's client electronic device. For instance, the application may display one or more instructions to the user for performing the target performance. The instructions may include one or more pictures, images, text, and/or videos showing the user how to perform the target performance. For example, the application may cause a video of an individual performing the target performance to display on the user's client electronic device.

In battle mode, two or more users may try to recreate a particular target performance and the user whose performance is determined to be the most similar to the target performance wins. The users in battle mode may receive one or more instructions for how to perform the target performance, such as, for example, as described above.

In considering whether an actual performance is similar to a target performance, various factors may be considered. For example, the sequence of actions in a target performance may be considered. As an example, a target performance may involve a user kicking a soccer ball off the ground above the user's head and then bouncing the soccer ball off the user's head. If the user only bounces the ball off of his or her head without first kicking the ball off of the ground, the performance may receive a low similarity score.

The interactions of the performance piece and the user may be considered in determining a similarity score. For example, if the target performance requires a user to hit a ball off of his or her right forearm and the user hits the ball off of his or her left forearm, the performance may receive a lower similarity score based on this mistake.

To start a performance, the provider electronic device will analyze one or more frames received from the client electronic device to determine whether a user interaction with a performance piece has occurred and whether the part of the user's body that interacted with the ball is the correct body part. If so, the provider electronic device may identify this interaction as the start of a user's performance and may continue to analyze frames and information after this time in determining a similarity score.

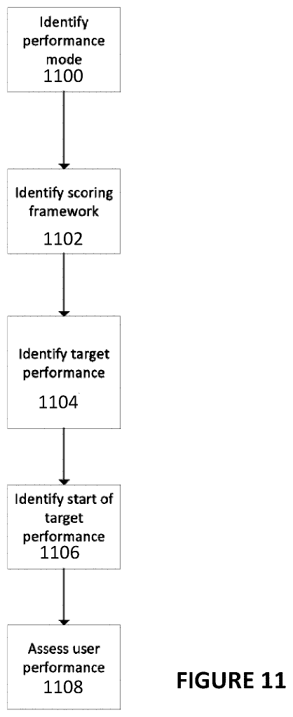

FIG. 11 illustrates a flow chart of an example method of analyzing a user's performance according to various implementations. As illustrated by FIG. 11, an electronic device such as, for example, a provider electronic device and/or a client electronic device, may identify 1100 a relevant performance mode. As explained above, single player mode and battle mode are two examples of modes. However, additional and/or alternate modes may be used within the scope of this disclosure. An electronic device may identify 1100 a relevant performance mode by receiving a selection made by a user via the user's client electronic device. For example, a user may select which mode the user would like to perform in via an application on the user's client electronic device, and this selection may be provided to the electronic device (in situations where the electronic device is different from the client electronic device).

An electronic device may identify 1102 a scoring framework associated with the identified mode. In various implementations, an electronic device may have or be able to access a data store that stores one or more scoring frameworks associated with one or more modes. For example, a single player mode may be associated with a similarity score scoring framework, while a battle mode may be associated with an amount completed scoring framework. Additional and/or alternate scoring frameworks may be used within the scope of this disclosure.

An electronic device may identify 1104 a target performance. The electronic device may identify 1104 a target performance by receiving a selection made by a user via the user's client electronic device. For example, a user may select which target performance the user would like to perform via an application on the user's client electronic device, and this selection may be provided to the electronic device.

An electronic device may identify 1106 a start of the target performance. As explained above, an electronic device may identify 1106 a start of a target performance by identifying an interaction between the user and a performance piece and confirming that the body part of the user involved in the interaction matches the body part that is supposed to perform the first interaction between user and performance piece in the target performance. For example, an electronic device may access a data store that includes information about interactions that occur as part of one or more target performance. This information may include, for one or more target performances, a sequence of interactions that occur and, for each interaction, a body part of a user involved in the interaction. Table 2 below illustrates example information from a target performance data store according to various implementations. As an example, an electronic device may identify an interaction between a user and a performance piece that involves the user's right arm. If the user is supposed to be performing Target Performance 1, the electronic device may identify this interaction as the start of the user's performance. However, if the electronic device identifies an interaction between a user and a performance piece that involves the user's left arm and the user is supposed to be performing Target Performance 1, the electronic device may not identify this interaction as the start of the user's performance and may continue to analyze the information received from the user's client electronic device until the start of the user's performance is detected.

TABLE 2
Target Performance 1

| Interaction | Body Part |
|---|---|
| Interaction 1 | Right arm |
| Interaction 2 | Left foot |
| Interaction 3 | Head |

After a start of a target performance is determined, an electronic device may analyze one or more frames and/or information that occur after the start of the performance to assess 1108 the user's performance in light of the applicable mode.

For example, in battle mode, a provider electronic device may assess the performance of multiple users to determine which user completed the largest part of the target performance. For example, a target performance may include discrete tricks performed in a certain sequence. In various implementations, evaluated tricks may be stored in one or more data stores associated with one or more provider electronic devices. The system may know what portion of a performance has been completed for one or more users. It may be possible to have a draw between two players. When a battle is played, a challenger may send a request to a provider electronic device to play with another user. The provider electronic device may store this information in one or more data stores and may notify the users when the evaluation is completed.

As another example, in single player mode, a provider electronic device may assess the performance of a user by generating a similarity score for the user's performance as compared to the target performance.

An electronic device may provide 1108 an evaluation to one or more users. The evaluation may be displayed on a user interface of one or more client electronic devices, for example those associated with the relevant user or users.

For example, for users performing in battle mode, a provider electronic device may send an indication of which user won to one or more client electronic devices associated with the users. As another example, for a user participating in single player mode, a provider electronic device may send an indication of how close the user's trajectory was to the original trajectory. This indication may be the similarity score or a derivative thereof. In other situations, a provider electronic device may translate a similarity score to a percentage based on how close a user's trajectory is to the original trajectory, and the provider electronic device may send this percentage to the user's client electronic device, which may cause the indication to be displayed to the user via a user interface.

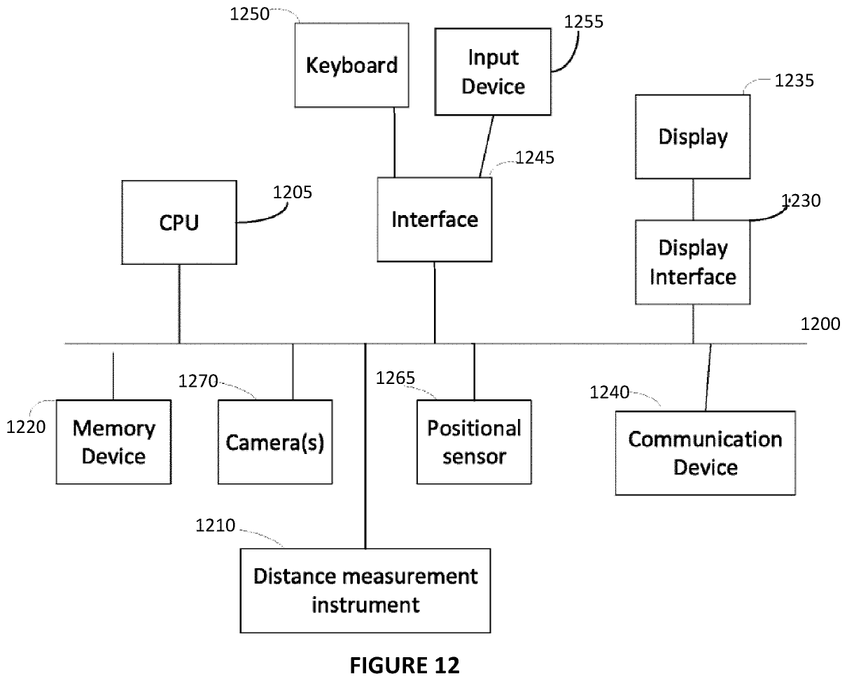

FIG. 12 depicts a block diagram of hardware that may be used to contain or implement program instructions, such as those of a client electronic device, a provider electronic device, a cloud-based server, electronic device, virtual machine, or container. A bus 1200 serves as an information highway interconnecting the other illustrated components of the hardware. The bus may be a physical connection between elements of the system, or a wired or wireless communication system via which various elements of the system share data. Processor 1205 is a processing device that performs calculations and logic operations required to execute a program. Processor 1205, alone or in conjunction with one or more of the other elements disclosed in FIG. 12, is an example of a processing device, computing device or processor as such terms are used within this disclosure. The processing device may be a physical processing device, a virtual device contained within another processing device, or a container included within a processing device.

A memory device 1220 is a hardware element or segment of a hardware element on which programming instructions, data, or both may be stored. Read only memory (ROM) and random access memory (RAM) constitute examples of memory devices, along with cloud storage services.

An optional display interface 1230 may permit information to be displayed on the display 1235 in audio, visual, graphic or alphanumeric format. Communication with external devices, such as a printing device, may occur using various communication devices 1240, such as a communication port or antenna. A communication device 1240 may be communicatively connected to a communication network, such as the Internet or an intranet.

The hardware may also include a user interface sensor 1245 that allows for receipt of data from input devices such as a keyboard 1250, a mouse, a joystick, a touchscreen, a remote control, a pointing device, and/or an audio input device 1255. Data also may be received from a camera 1225. A positional sensor 1265 may be included to detect position and movement of the device. Examples of positional sensors 1265 include a global positioning system (GPS) sensor device that receives positional data from the external GPS network, a gyroscope, an accelerometer or an inertial measurement unit (IMU). In some embodiments, the camera data may be used as a positional sensor using technologies available in now or hereafter known computing platforms. Also, as noted above the system may include or be communicatively connected to one or more distance measurement instruments 1210 such as a laser distance measurement device. The user interface also may include one or more cameras 1270 that can capture video and/or still images.

An “electronic device” or a “computing device” may be a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions. Examples of electronic devices include personal computers, servers, mainframes, virtual machines, containers, gaming systems, televisions, and mobile electronic devices such as smartphones, personal digital assistants, cameras, tablet computers, laptop computers, media players and the like. In a client-server arrangement, the client device and the server are each electronic devices, in which the server contains instructions and/or data that the client device accesses via one or more communications links in one or more communications networks. In a virtual machine arrangement, a server may be an electronic device, and each virtual machine or container may also be considered to be an electronic device. A client device, server device, virtual machine or container may be referred to simply as a “device” for brevity.

The “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. A “performance” refers to a sequence of tricks or other actions performed by a user. For example, a performance may include a first trick of the user kicking a soccer ball off of the ground followed by a second trick of the user bouncing the soccer ball off of the user's head. A “performance piece” refers to an object that a user interacts with during a performance. Example performance pieces may include, without limitation, soccer balls, football balls, hockey pucks, other types of balls, and/or other objects. The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process. A “trick” refers to one or more actions performed by a user. A trick may involve the use of a performance piece. For example, a trick may involve bouncing a soccer ball off a user's head.

The features and functions described above, as well as alternatives, may be combined into many other different systems or applications. Various alternatives, modifications, variations or improvements may be made by those skilled in the art, each of which is also intended to be encompassed by the disclosed embodiments.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. An apparatus, comprising:
a computing device with a processor and memory in communication with a mobile device having a processor and at least one integrated digital camera, and the computing device having a plurality of programming instructions that, when executed by the processor, cause the computing device to:
receive digital image data from the mobile device with integrated camera, wherein the received digital image data RGB image data and includes time meta data,
detect, by machine learning, at least one object in the received image data,
determine pixel coordinates in the digital image data for each detected object using bounding boxes that encompass the detected object,
refine the determined pixel coordinates using a filter that detects and filters any outliers in the detected object coordinates using the detected object coordinates in a minimum of two image frames prior to a current image frame,
identify if any detected object is a user, and if so, generate one or more skeleton coordinates of the user in the received digital image data,
determine if any detected object is a ball, if so, generate detected ball coordinates and localize the detected ball coordinates using a circle detection algorithm to determine a diameter of the detected ball in pixel coordinates,
determine a physical distance from the detected ball to the integrated mobile device camera when the digital image data was captured, using an assumed standard ball diameter size,
predict future coordinates of the detected objects on a minimum of ten image frames in a projective space for each incoming image frame, using a plurality of determined skeleton and ball coordinates in a minimum of two image frames prior to a current image frame,
associate the predicted object coordinates in the projective space with corresponding determined object coordinates in subsequent image frames to generate a mapping difference,
determine for any of subsequent image frames, if the generated mapping difference in at least one of the object coordinates exceeds an empirically set threshold and if so, flag the determined image frame by metadata, indicating a direction change of the corresponding detected object,
cause display in the mobile device of the generated mapping difference in real-time for each image frame including the current determined object coordinates overlaid on the image frame,
map the pixel coordinates of the detected objects for the image frames and corresponding performance mode into a normalized coordinate space accounting for sizes of the detected ball and detected skeleton by synchronizing a reference digital image data and received digital image data in time to ensure uniform speed for accurate comparison, and
associate a sequence of the determined object pixel coordinates in the image frames with a corresponding performance mode in the normalized coordinate space.

2. The apparatus of claim 1 further comprising one or more distributed computing resources in communication with the computing device, the distributed computing resources with one or more programming instructions that, when executed, cause the distributed computing device to: receive at least a portion of the received image data from the computer the received image data including detected object coordinates and predicted object coordinates in the projective space.

3. The apparatus of claim 2, wherein the one or more distributed computing resources plurality of instructions executed by the processor further cause the one or more distributed computing resources to receive the image data and predict object coordinates on a minimum of ten image frames in a projective space parameterized by at least one of, determined kinetic activity of the user, overall size of the detected skeleton on a minimum of two image frames, perspective deformations of the integrated digital camera in the mobile computing device, object occlusion by another object, determined distance of the ball from the integrated digital camera, and sensed lighting conditions and contrast in textures of the ball and background.

4. The apparatus of claim 1 further comprising one or more distributed computing resources, in communication with the computing device, that each have a processor that executes a plurality of lines of instructions to cause the one or more distributed computing resources to receive the reference image data associated with the performance mode together with the object coordinate data for each image frame of the reference image data.

5. The apparatus of claim 4, wherein the one or more distributed computing resources are further caused to: identify from the image data an image frame that indicates a beginning of a task associated with the performance mode by associating determined and predicted object coordinates in the projective space, and use object coordinates in the reference image data associated with the identified performance mode.

6. The apparatus of claim 5, wherein the one or more distributed computing resources are further caused to: register a sequence of the determined object coordinates at discrete time instances together with the detected changes in direction of the movement after the start time, until an end and utilize the sequence of the determined object coordinates in a grading framework associated with the mode.

7. The apparatus of claim 6, wherein the one or more distributed computing resources are further caused to: generate a grading result for the detected object coordinates as compared to target coordinates.

8. The apparatus of claim 4, wherein the one or more distributed computing resources are further caused to: receive a selection of the mode from the user from the mobile computing device.

9. The apparatus of claim 4, wherein the one or more distributed computing resources are further caused to: send a grading result of the object coordinates to the mobile computing device.

10. The apparatus of claim 9 wherein the grading result comprises an indication of how closely the performance compares to the coordinates in the reference images associated with identified mode.

11. A method comprising:
by a computer with a processor and memory,
receiving digital image data from a mobile device with an integrated camera,
detecting, at least one object in the received image data,
determining pixel coordinates in the digital image data for each detected object using bounding boxes that encompass the detected object,
identifying if any detected object is a user, and if so, generating one or more skeleton coordinates of the user in the received digital image data,
determining if any detected object is a ball, if so, generating detected ball coordinates and localizing the detected ball coordinates using a circle detection algorithm to determine a diameter of the detected ball in pixel coordinates,
determining a physical distance from the detected ball to the mobile device integrated camera at the time the digital image data was captured, using an assumed standard ball diameter size,
predicting future coordinates of the detected objects on a minimum of ten image frames in a projective space for each incoming image frames, using a plurality of determined skeleton and ball coordinates in a minimum of two image frames prior to a current image frame,
associating the predicted object coordinates in the projective space with corresponding determined object coordinates in subsequent image frames for generating a mapping difference,
determining for any of subsequent image frames, if the generated mapping difference in at least one of the object coordinates exceeds an empirically set threshold and if so, flagging the determined image frame by metadata, indicating a direction change of the corresponding detected object,
causing display, by the mobile device, the generated mapping difference in real-time for each image frame including the current determined object coordinates overlaid on the image frame,
mapping the pixel coordinates of the detected objects for the image frames and corresponding performance mode into a normalized coordinate space accounting for sizes of the detected ball and detected skeleton, and
associating a sequence of the determined object coordinates in the image frames with a corresponding performance mode.

12. The method of claim 11 further comprising, by the computer, refining the determined pixel coordinates using a filter that detects and filters any outliers in the detected object coordinates using the detected object coordinates in a minimum of two image frames prior to a current image frame.

13. The method of claim 11 wherein the object detection in the received image data is achieved by using machine learning at the computer using the received image data to generate the object bounding box data for each object in the received data.

14. The method of claim 11 further comprising, by the computer, receiving a selection of performance mode and corresponding reference image data, and the object coordinate data for each image frame of the reference image data, identifying a scoring framework associated with the identified mode, and use the identified scoring framework in the assignment of the score.

15. The method of claim 14 further comprising, by the computer, identifying from the image data an image frame that indicates a beginning of a task associated with the performance mode by associating determined and predicted object coordinates and using object coordinate data in the reference image data associated with the performance.

16. The method of claim 15 further comprising, by the computer, registering a sequence of the determined object coordinates at discrete time instances together with the detected changes in direction of the movement after the start time, until an end and utilize the sequence of the determined object coordinates in a grading framework associated with the mode.

17. The method of claim 16, by the computer, generating a grading result comprising an indication of correspondence between the sequence of mapped object coordinates in the image data and the sequence of mapped object coordinates in reference image data in the normalized coordinate space.

18. The method of claim 14, further comprising, by the computer, sending the grading results to a mobile computing device in communication with the computer.

19. The method of claim 11 further comprising, by the computer, accounting for a synchronicity in motion between sequence of determined pixel coordinates and corresponding performance mode.
